(19) United States
(12) Patent Application Publication
(10) Pub. No.: US 2010/0206700 A1
(43) Pub. Date: Aug. 19, 2010

(54) Chain Guiding Mechanism for a Linear Motion Machine

(76) Inventor: Cheng-Feng LIN, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/388,614

(22) Filed: Feb. 19, 2009

(51) Int. Cl. B65G 15/62

(52) U.S. Cl. 198/841

(57) ABSTRACT

A chain guiding mechanism for a linear motion machine comprises a support member and a linear motion device. The support member cooperates with a chain and the linear motion machine to move, respectively. The support member is disposed on the linear motion device for carrying a part of the weight of the chain, so as to prevent the chain from vibration, thus avoiding influencing the displacement precision of the linear motion machine.

### BACKGROUND OF THE INVENTION

1. Field of the Invention

The present invention relates to a chain for a linear motion machine, and more particularly to a chain guiding mechanism for a linear motion machine.

2. Description of the Prior Art

A conventional linear motion machine is usually provided with a chain for protecting wires or pipelines from abrasion or external interference.

Referring to FIG. 1, a conventional linear motion machine 90 is connected to a chain 91 via a chain guiding mechanism 92. However, the chain guiding mechanism 92 is likely to deform if it is too long, plus the weight of the chain 91 is loaded on the chain guiding mechanism 92. At this time, the deformed chain guiding mechanism 92 will probably vibrate along with the displacement of the linear motion machine 90, and as a result, the displacement precision of the linear motion machine 90 will be influenced.

The present invention has arisen to mitigate and/or obviate the afore-described disadvantages.

### SUMMARY OF THE INVENTION

The primary objective of the present invention is to provide a chain guiding mechanism for a linear motion machine which utilizes a linear motion device to carry a part of the weight of a chain, so as to prevent the chain from vibration, thus avoiding influencing the displacement precision of the linear motion machine. To achieve the objective of the present invention, the chain guiding mechanism for a linear motion machine comprises a support member and a linear motion device. The support member cooperates with the chain and the linear motion machine to move, respectively. The linear motion device serves to carry and move the support member.

It is apparent from the above-mentioned descriptions that the present invention has the advantages described as follows: through the cooperation of the support member and the linear motion device, the capability of the support member for carrying the chain is improved, which not only makes it possible for the support member to be light weight, but also reduces the vibration of the support member, thus improving the motion accuracy of the linear motion machine.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a plane view of a conventional linear motion machine in accordance with the present invention;

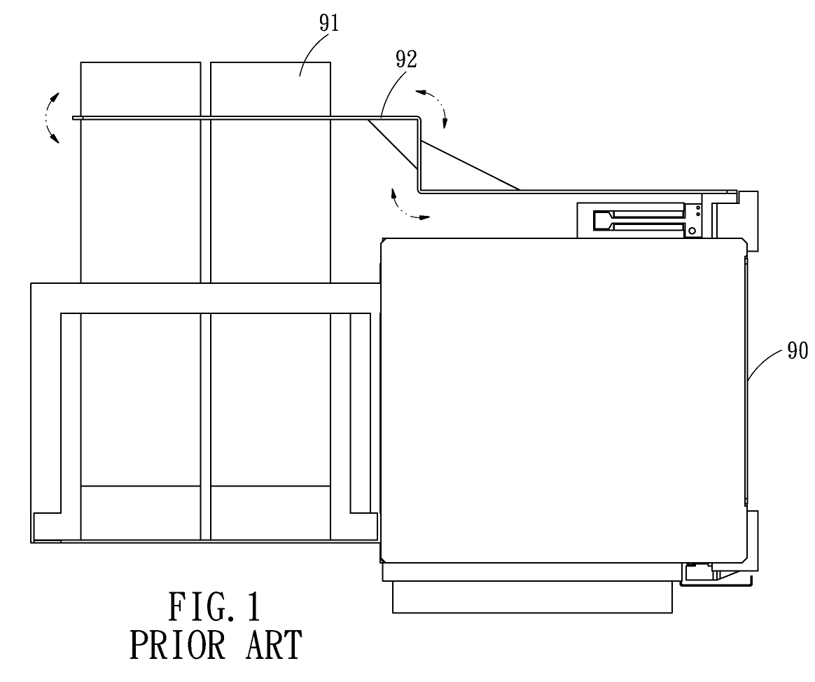

FIG. 2 is a perspective view of a chain guiding mechanism for a linear motion machine in accordance with the present invention; and

FIG. 3 is a plane view of the chain guiding mechanism for a linear motion machine in accordance with the present invention.

### DETAILED DESCRIPTION OF THE PREFERRED EMBODIMENTS

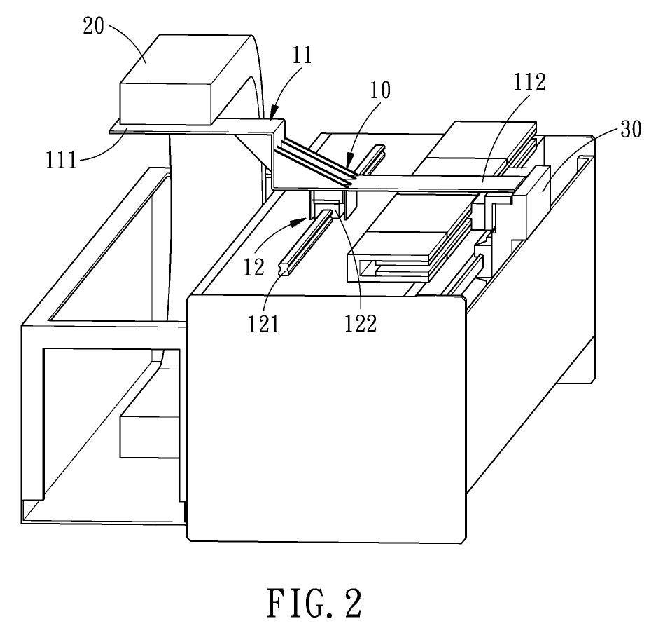

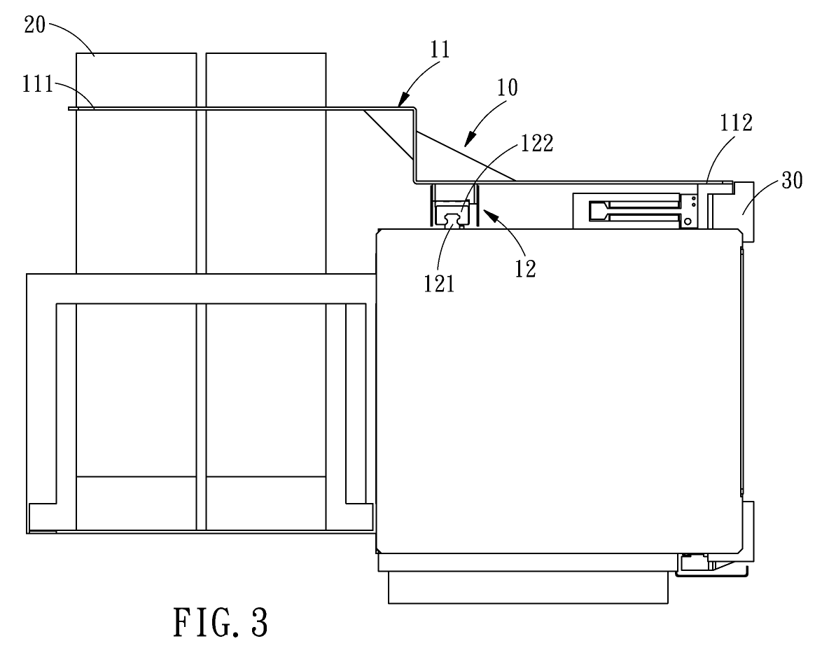

Referring to FIGS. 2 and 3, a chain guiding mechanism 10 for a linear motion machine 30 in accordance with the present invention comprises a support member 11 and a linear motion device 12.

The support member 11 is a plate and cooperates with a chain 20 and the linear motion machine 30 to move, respectively. Both ends of the support member 11 are provided with a first assembly portion 111 and a second assembly portion 112, respectively. The first assembly portion 111 of the support member 11 is detachably assembled to the chain 20 by screws, and the second assembly portion 112 of the support member 11 is detachably assembled to the linear motion machine 30 by screws.

The linear motion device 12 comprises a rail 121 and a slide block 122. The rail 121 is detachably assembled to the linear motion machine 30. The chain 20 is provided at one side of the linear motion machine 30. The bottom of the slide block 122 is movably assembled to the rail 121, and the support member 11 is detachably assembled to the top of the slide block 122 by screws.

When the linear motion machine 30 drives the support member 11 to move, the chain 20 will move along with the support member 11, and the slide block 122 of the linear motion device 12 carries the support member 11 and moves with respect to the rail 121.

While we have shown and described various embodiments in accordance with the present invention, it should be clear to those skilled in the art that further embodiments may be made without departing from the scope of the present invention.

What is claimed is:

1. A chain guiding mechanism for a linear motion machine, comprising:
a support member detachably assembled to a chain and the linear motion machine, respectively; and
a linear motion device for carrying and moving the support member.

2. The chain guiding mechanism for a linear motion machine as claimed in claim 1, wherein a first assembly portion and a second assembly portion are provided at both ends of the support member, the first assembly portion of the support member is detachably assembled to the chain, the second assembly portion of the support member is detachably assembled to the linear motion machine, the linear motion device comprises a rail and a slide block, a bottom of the slide block is movably assembled to the rail, and the support member is detachably assembled to a top of the slide block.
